(19) United States
(12) Patent Application Publication
(10) Pub. No.: US 2009/0037378 A1
(43) Pub. Date: Feb. 5, 2009

(54) AUTOMATIC GENERATION OF FORMS BASED ON ACTIVITY

(75) Inventors: Crisler Terrill Moor, San Jose, CA (US); Lance Christopher Rodenfels, Fairview Park, OH (US); Robert J. McGreevy, Oswego, IL (US); Richard Lee Ryan, Pleasanton, CA (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/832,692

(22) Filed: Aug. 2, 2007

(51) Int. Cl. G06F 3/14; G06F 17/30

(52) U.S. Cl. 707/3; 715/222; 707/E17.014

(57) ABSTRACT

A user can be presented with a form or other record that can enable efficient performance of various actions including a workflow or process. As actions are performed, the user can be presented with different forms more applicable to a current task being performed. The forms can be automatically created and modified, or a user can request various changes or updates to the form. A language associated with the form or other information can be changed from a first language to a second language based upon a request for the change.

### TECHNICAL FIELD

The following description relates generally to industrial automation systems, and more specifically to machine execution systems.

### BACKGROUND

Complete or partial automation in factories, manufacturing facilities, and the like is possible through utilization of industrial control systems. A logic processor, such as a programmable logic controller (PLC) lies at the core of the industrial control system. PLCs can be programmed to operate manufacturing processes through logic programs and/or routines. These programs can be stored in memory and generally are executed by the PLC in a sequential manner, although instruction jumping, looping, and interrupt routines are also common. Industrial control systems typically include a plurality of input and output (I/O) modules communicatively coupled to the PLC through a backplane that interferes at a device level to switches, contactors, relays, solenoids and sensors, among other devices. Accordingly, such control systems are optimized to control and monitor industrial processes, machines, manufacturing equipment, industrial plants, and the like.

In addition to PLCs, advances in computing technology allow businesses to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Technology advancements have also enabled factory applications to become partially or completely automated.

Manufacturing Execution Systems (MES) are another technological development that assists in facilitating communications between a production or assembly floor and other departments (e.g., research and development, purchasing, production control, quality, testing, and so forth). As technology continues to advance it is desirable to utilize the full capabilities of the various forms of technology in order to increase efficiency of a multitude of processes including worker efficiency and/or worker understanding and implementation of actions or a desired workflow. Utilization of such technology to its fullest has been overlooked and generally has not been designed to optimize worker competence, completion of actions, including self-training, and/or continuous improvement as well as to overcome language barriers that may exist within the workplace.

### SUMMARY

The following presents a simplified summary in order to provide a basic understanding of some aspects of the disclosed examples. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with providing a configurable form or user interface that can be automatically generated (e.g., without user intervention) based on actions and/or activities or sets of actions/activities. Such actions/activities can be derived from historical information (data repository), observation of a current action/activity, an expected action/activity or other criteria. The relevant form(s) or user interface screen can further be provided at the optimal time for a user to implement an action. The form(s) or user interface can be presented (e.g., visually, audibly or through other readily perceivable means) at particular points of a process to prompt a next action or recommend an action. In accordance with some aspects, the forms can be automatically generated based on definitions of activities and the workflow of such activities.

The configurable form, user interface or other information can be selectively modified based on the language understood by the user. For example, a particular form or user display can be changed from French to English (or other languages) based on input from a user (e.g., a different user is to operate the machine) or the same user desires a different language. The language or text can be automatically converted to the desired language and can further change various other parameters of the user display. Such parameters include number formatting, metric to English conversion, configuration of the display (left to right language, or right to left language), date formatting and so on.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates an example system that provides automatic generation of a configurable form in accordance with the aspects disclosed herein.

FIG. 2 illustrates an example system that monitors actions and provides guidance to a user.

FIG. 3 illustrates another example system for evaluating various actions and presenting a user with a workflow at an optimal time for efficiency purposes.

FIG. 4 illustrates another example system for providing a configurable user interface that can be displayed in numerous changeable languages.

FIG. 5 illustrates a system that employs machine-learning techniques that can facilitate automating one or more features in accordance with the one or more aspects disclosed herein.

FIG. 6 illustrates a method for presenting a user with a form based in part on an observed activity.

FIG. 7 illustrates a method for dynamically monitoring activities and providing guidance for completion of such activities.

FIG. 8 illustrates a method for providing information relating to an activity or set of activities and modifying information based on requested feedback.

FIG. 9 illustrates a method for providing information related to evaluated activities and dynamically altering a language of an output based upon a request for such a change.

FIG. 10 illustrates a block diagram of a computer operable to execute the disclosed embodiments.

FIG. 11 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used.

The various embodiments disclosed herein can operate separately or in conjunction with numerous systems including Advanced Process control, various business systems, manufacturing or machine execution systems (MES), MES Appliances, and so forth. A MES system can include integration with an Enterprise business system, Quality system, Warehouse and supply chain systems, and so forth. An MES system can include key functions, such as detailed scheduling, work order execution and dispatching, definition management, resource management, data collection, and order management. An MES Appliance can perform processing related to various aspects (e.g., business logic, data storage, and so on), can be incorporated on software modules that can operate various aspects of a business, manufacturing environment and the like and can operate and be serviced utilizing various information technology resources. The multitude of systems can directly or indirectly derive their value out of configuration and interaction with Manufacturing/Automation systems and/or MES type systems. Additionally, the various aspects can be employed in an industrial automation environment and/or in other environments in which such aspects are deemed appropriate.

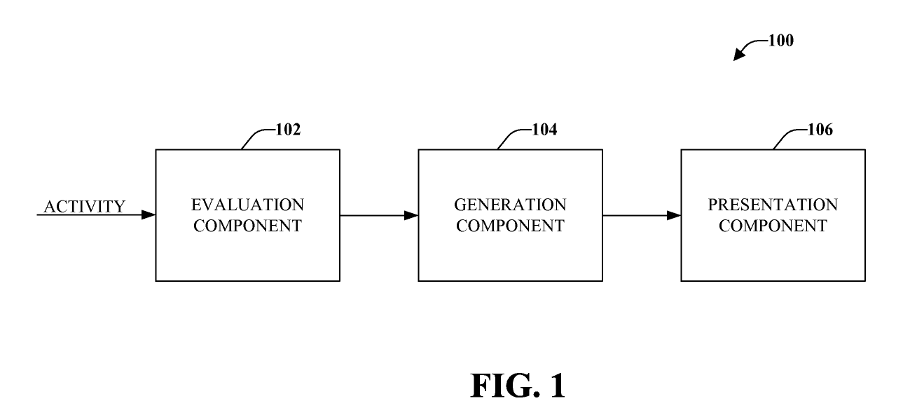

Referring initially to FIG. 1, illustrated is an example system 100 that provides automatic generation of a configurable form in accordance with the aspects disclosed herein. The term “form” as used herein is meant to refer to a record, a visual record, a flowchart, a document, a message, a snapshot, a statement, recorded material, a record that can be output through audible means or through other means (e.g., color coding, audible tone interpretation and so forth) or other perceivable items.

System 100 can be configured to generate, modify and/or obtain a form based on actions and/or activities or sets of such actions and/or activities (e.g., steps in a workflow). More than one form can be generated for a given action or action set. The actions and/or activities (or sets) can be tasks or other procedures, including work procedures or processes. The activities or set of activities can, likewise be part of a service. In accordance with some aspects, the activity can be a configured component that performs an MES function.

System 100 can be configured to generate the form without user intervention, such as through a vision system or other system that can automatically monitor and/or record activities associated with system 100 (e.g., performed directly on the system or in the vicinity of system). Additionally, the form can be manually configured by a user, as desired. In accordance with some aspects, the form can be automatically configured if system 100 determines that modifications are necessary based on continuing activities or other events (e.g., end of a work shift). System 100 can further be configured to selectively present a different form if a current form is no longer useful for the current situation (e.g., the user is finished with one action and is starting a different action, such as a next work process).

In further detail, system 100 includes an evaluation component 102 that can be configured to monitor and evaluate one or more actions. For example, evaluation component 102 can monitor a user's actions and determine whether such actions occur in a particular sequence or pattern and/or if there is a consistency in the action(s). Alternatively or additionally, evaluation component 102 can evaluate the user, the action, the equipment and/or other parameters that might have an influence on the observed action(s). In accordance with some aspects, evaluation component 102 monitors inputs and outputs from a PLC or other machinery.

Also included in system 100 can be a generation component 104 that can be configured to create a form that is a representation of the evaluated actions and other parameters. Thus, generation component 104 might create the form based not only on the actions but also on previously received information. For example, generation component 104 might receive information from evaluation component 102 indicating that the user is not familiar with the activity/action (e.g., might perform unnecessary or redundant actions, might perform an action out of order, might incorrectly perform the activity and so on) or if the user is experienced (e.g., confidence level that the work is being performed efficiently). Such information can be taken into consideration by generation component 104 when a form is generated. Additionally or alternatively, generation component 104 can be configured to obtain previously generated forms from a form repository and/or obtain information related to the action(s) from a data repository in order to create and/or modify a form.

The form can be output by presentation component 106. The output might be on a display, such as a screen, or an audible output, such as voice or other audible means or through another means (e.g., email, printout, text message, and so forth). The user can receive the outputted form and, as necessary, perform modifications to the form and/or suggest such modifications be made by system 100. In accordance with some aspects, system 100 might automatically modify the form if it is determined that the presented form is incorrect.

In accordance with some aspects, advanced analytics are utilized whereby the activities are recorded and at substantially the same time or at a different time the activities are analyzed. For example, a user can be operating a machine (such as an industrial automation machine, an MES Appliance and so forth) and it is observed that the user (or a different person such as a mechanic or repair technician) approaches the machine with a drill driver. The drill driver can be detected independently from the person and interpreted as repair work that indicates repair might be performed on the machine. In such a situation, an output can be presented to the user with a prompt indicating if repair work will be performed and requesting a “yes” or “no” response, for example. The user can reply to such a prompt and, if a positive reply is received, the machine can automatically be place in condition for repair (e.g., pumps or motors shut down, conveyor belt movement stopped and so forth). If the reply to the prompt indicates that a repair is not to be performed, the current machine operation can continue. In accordance with some aspects, if a reply to the prompt is not received within a predetermined amount of time, the command is cancelled (e.g., the machine operation continues), however, other actions can be performed (e.g., the machine is shut down for safety reasons).

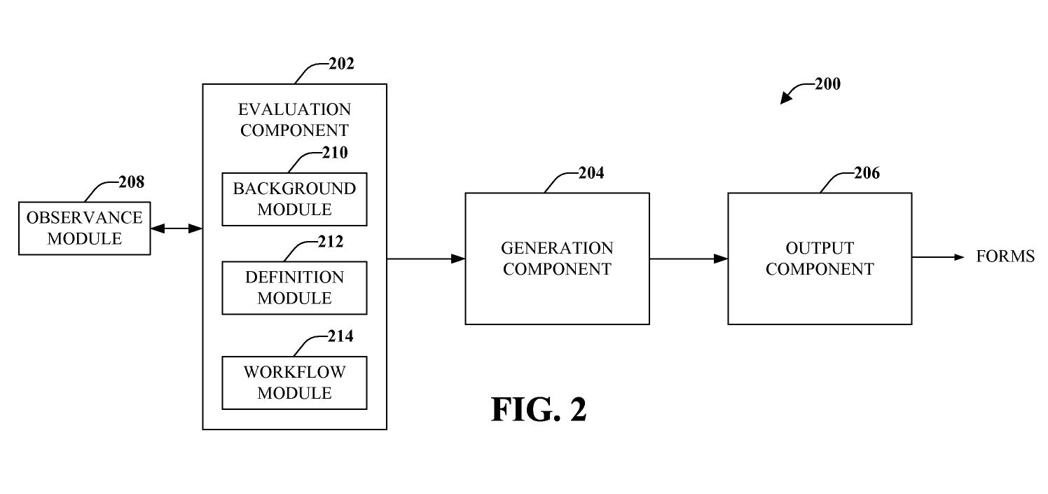

FIG. 2 illustrates an example system 200 that monitors actions and provides guidance to a user. System 200 can be configured to monitor and evaluate various actions performed by a user that can relate to known processes and/or can be new processes, which can be learned by system 200. In order to monitor such actions, system 200 can employ various techniques of observance and capturing of actions.

In further detail, system 200 includes an evaluation component 202 that interacts with a generation component 204 and an output component 206 to provide user guidance relating to a recommended action, a sequence of actions, or other information. To observe actions by a user, evaluation component 202 can be associated with an observance module 208 that can be configured to view activities by a user or a group of users. For example, observance module 208 can be a camera, video recorder, vision system or other device that can capture pictures (still or moving), receive a user input (e.g., key strokes, voice commands, and so forth) or can be another device that can readily monitor or perceive actions or events at substantially the same time as the actions or events occur. By way of example and not limitation, observance module 208 can detect a user picking up a screwdriver and such action can be evaluated or logged as a repair.

In accordance with some aspects, observation module 208 can be configured to capture and/or maintain such observed actions. For example, observation module 208 can include memory and/or some other medium that can store information, which can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Evaluation component 202 can include a background module 210 that can be configured to obtain and/or determine various background parameters relating to the background of a user, a particular action or set of actions, machinery, or other items associated with the actions. A background of a user can relate to whether the user is a novice at the action, very experienced at performing the action or any state there between. A novice user might perform tasks that are redundant, unnecessary, out of order and/or actions that might not be efficient. A background of the action might relate to whether the action, such as a process, is new or has been tested (e.g., performed a number of times previously). If it is a new process, the order of steps or the number of steps in the process might need changing after the process has been performed a few times. If the process is tested, more reliance can be placed on the process.

In accordance with further aspects, a background of the machinery might relate to whether the machinery is new or is older and thus might have worn parts that might not be operating within tolerances or at high capacity. The machinery background might also relate to whether the machinery is due for preventive maintenance, has had historical breakdowns, breakdowns associated with similar machinery or other factors that might have an affect on an action performed with the machinery. The machinery background might also relate to trends or data collected across multiple sites (e.g., a single company, multiple companies, across certain industries, across cross-sections of industries and so on). Thus, in accordance with some aspects, system 200 allows for remote services and/or management of equipment (e.g., a form can recommend a next action to be performed such as routine maintenance, recommended maintenance, product recalls and so forth).

Also associated with evaluation component 202 can be a definition module 212, which can be configured to request or obtain one or more definitions associated with an activity. For example, for a particular action a user prompt can be activated for a definition of the activity, wherein the definition can include an activity name, an estimated time for completion of the activity, a reason for the activity as well as other parameters. In accordance with some aspects, definition module 212 can obtain the one or more definitions based on a received input (e.g., the name of the action). One or more definitions of the activity can be provided to generation component 204 to facilitate generation of a form.

A workflow module 214 associated with evaluation component 202 can be configured to receive or obtain a process or steps associated with the observed activity. For example, workflow module 214 might request information regarding whether the observed action is a single action or if the observed action is a subpart of a series of actions. If the action is a single action, the observed action might be disregarded. If the action is part of a series of actions, further information relating to the action/series of actions might be requested (e.g., definitions, number of steps in the sequence, where within the sequence this action belongs and so forth).

The information obtained by evaluation component 202 can be communicated to generation component 204, which can create a new form and/or modify an existing form. At substantially the same time as the form is created and/or modified, an output component 206 can present the results to a user. As such, the user can utilize the form to complete an activity or to more efficiently perform an activity. By way of example and not limitation, a warehouse management system can be configured to interact with a control system for execution in a warehouse and also to interact with either or both an Enterprise Resource Planning (ERP) system and a MES system. As rules are built for specification routing and other functions, forms can be automatically generated based on existing knowledge of systems and functions associated with those systems.

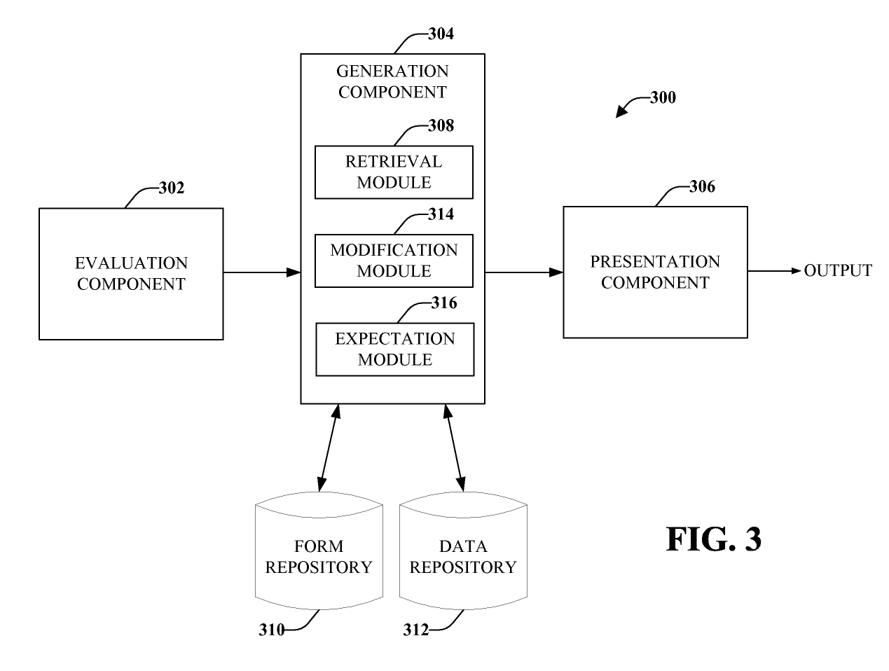

With reference now to FIG. 3, illustrated is another example system 300 for evaluating various actions and presenting a user with a workflow at an optimal time for efficiency purposes. System 300 is similar to the systems 100, 200 of the above figures and includes an evaluation component 302 that observes various activities and a generation component 304 that can create and/or modify various forms that can be presented to a user by presentation component 306.

In further detail, generation component 304 includes a retrieval module 308 that can be configured to access a form repository 310 and/or a data repository 312 to obtain information relating to the observed activity. The form repository 310 can maintain previously generated forms and/or predefined forms (e.g., manually defined). Retrieval module 308 can choose an appropriate form based, in part, on the monitored activity as well as other information obtained by evaluation component 302. The information retained in data repository 312 can include information previously gathered from the same or a different user and/or related to the same and/or different action or other information (e.g., business goals, production goals and so on).

Generation component 304 can further include a modification module 314 that can be configured to determine changes that would be appropriate for a retrieved form. The determination of the changes might relate to evaluation component 302 monitoring a novice user and, as experience is gained and the user becomes more efficient, changing the form to reflect the increased efficiency on the form, such as in the form of a process or steps. Additionally, it might be determined to make other changes based on information obtained from the data repository 312 and/or based on input from a user.

Generation component 304 can also include an expectation module 316 that can be configured to anticipate a next action based in part on the monitored activity. For example, if a new task is being performed, expectation module 316 might anticipate a next action based on similar tasks performed by the user and/or maintained in either repository 310, 312. Expectation module 316 can further be configured to request and/or send a notification that a different form might be more appropriate for a next action. As the user performs actions that are continuously monitored, as appropriate, different forms can be presented to the user, wherein such forms are more fitting to a particular purpose. As it relates to Advanced Process Control, a model could be built and forms for reporting and/or feedback from other systems (e.g., PLC, ERP, and so forth) can be automatically generated based on model development, for example.

Additionally, generation component 302 at substantially the same time as creating and/or modifying a form can send the form to the form repository 310 for storage in a readily retrievable format. In accordance with some aspects, a modified form is retained separately from a previous version of the form. The created and/or modified form can be displayed to the user, through presentation component 306.

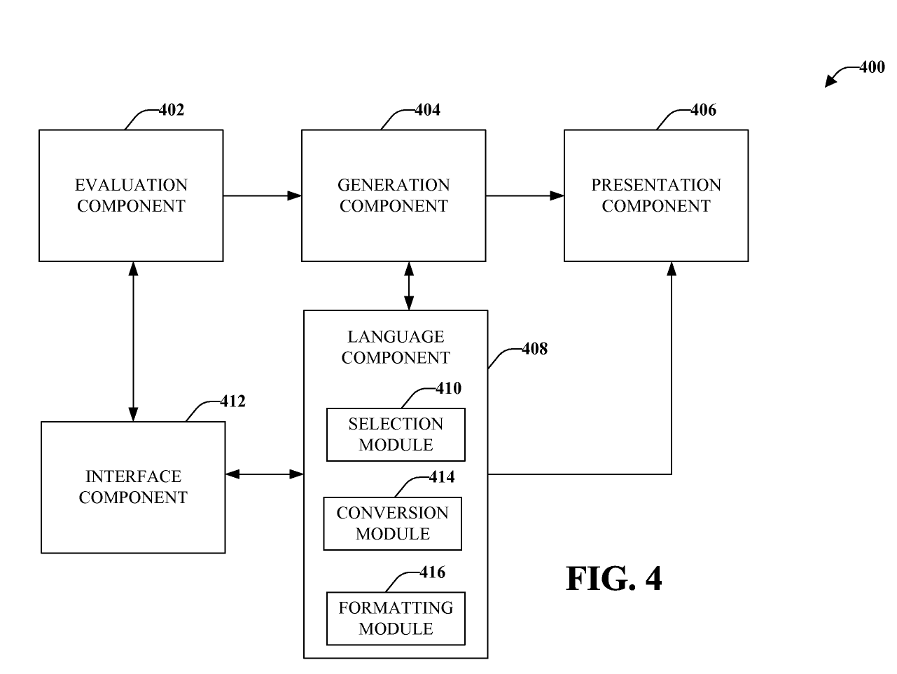

FIG. 4 illustrates another example system 400 for providing a configurable user interface that can be displayed in numerous changeable languages. System 400 can be configured to support a number of languages (e.g., French, Spanish, Arabic, English, German, Dutch, Italian, Japanese, Icelandic, Romanian and so forth). The languages can be selectively changed (e.g., from a first language to a second language) based on a received request. System 400 can include an evaluation component 402, a generation component 404, and a presentation component 406 that can be similar to the components of the above-described systems 100, 200, 300.

As described above, evaluation component 402 can be configured to analyze an observed activity and relay information related to the observed activity to generation component 404. A new form and/or modification to an existing form can be configured by generation component 404 and the resulting output displayed to a user by presentation component 406.

System 400 can further include a language component 408 that can interface with the other system components 402, 404, 406. Language component 408 can include a selection module 410 that can be configured to receive a request to change output information from a first language to at least a second language. Selection module 410 can interface with an interface component 412, which can include a user interface wherein a user can selectively request a change from a first language to a second language and then a third language (or back to the first language) and so forth.

Interface component 412 can provide various types of user interfaces such as a graphical user interface (GUI), a command line interface, a speech interface, Natural Language text interface, and the like. For example, a GUI can be rendered that provides a user with a region or means to load, import, select, read, etc. various information relating to activities and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

In the event of a language change, a conversion module 414 can be configured to convert language parameters to facilitate translation to the desired language. For example, conversion module 414 can be configured to change a metric unit of measurement to an English unit of measurement or other measurement, depending on the language selected. Conversion module 414 can further be configured to change numbers into the proper format for the language selected. Date and/or time structure changes can also be facilitated by conversion module 414.

Also included can be a formatting module 416 that can be configured to change the formatting associated with the newly selected language. For example, a first language might be read from right to left while a second message is read from left to right. Formatting module 416 can automatically apply such changes to a display screen at substantially the same time as the language change is requested.

It should be understood that similar principles can be applied when, instead of a display, another perceivable means of obtaining information is utilized with the disclosed aspects. For example, if an audible means is provided for conveying the information (e.g., speech recognizable format), language component 408 can provide the selected language in an audible manner.

In accordance with some aspects, interface component 412 can further provide a means for a user to input information relating to an activity or set of activities. For example, the user can input a name of an activity, steps in a process or other information (e.g., scheduled maintenance of equipment, user name, user experience level, name of related or similar activities, and so forth). In such a manner, a user can interact with system 400 to obtain the desired information, contribute information and/or change one or more parameters of system 400.

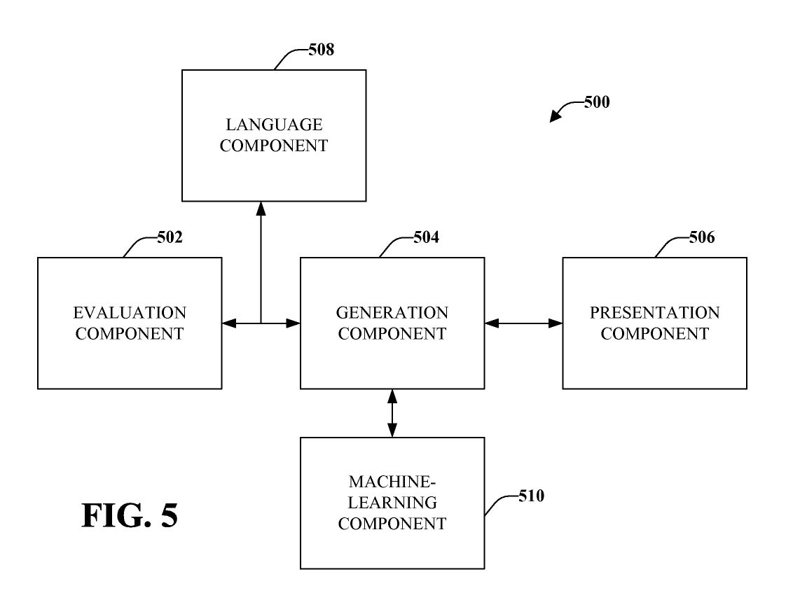

FIG. 5 illustrates a system 500 that employs machine-learning techniques that can facilitate automating one or more features in accordance with the one or more aspects disclosed herein. The various aspects (e.g., in connection with providing a form or other perceivable guidance means and/or facilitating language changes) can employ various machine learning-based schemes for carrying out various aspects thereof.

The machine learning component 510 can employ various machine learning techniques, algorithms, approaches, etc. to identify and/or detect text in data (e.g., artificial intelligence, rules based logic and so forth). For example, the machine-learning component 510 can employ a machine-learning algorithm that can reason about or infer a process for determining if a particular form should be presented to a user at a specific time, which can be facilitated through an automatic classifier system and process. In another example, a process for determining whether a particular form should be modified based on various external (e.g., observed events) and internal (e.g., historical data) factors can be facilitated through an automatic classifier system and process. Inference can be employed to identify a context and/or can generate a probability distribution over the input data and/or components identified within this input as potential text. Such inferences can be probabilistic—that is, the computation of a probability distribution over entities identified within the data. Inference can also refer to techniques employed for rendering higher-level decisions.

Various classification (explicitly and/or implicitly trained) schemes and/or systems (e.g., boosting classifiers, transduction classifiers, inductive classifiers, support vector machines, neural networks, expert systems, Bayesian belief networks, fuzzy logic, data fusion engines . . . ) can be employed in connection with performing automatic detection of activities and/or activity sets in accordance with the disclosed examples. In general, a classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to automatically differentiate text from other entities within an image. One example of a suitable classifier is a support vector machine (SVM), which, in general, operates by finding a hypersurface, which attempts to split triggering criteria from non-triggering criteria, in the space of possible inputs. This can make the classification suitable for testing samples, data, etc. that is near, but not identical to training data. The classifier(s) can be used to automatically learn and perform a number of functions, including but not limited to determining according to a predetermined criteria when to present a form to a user, when to change a form, when to output a different form, etc. The criteria can include, but is not limited to, the amount of steps or a sequence of activities described by the form, the type of activity, the user performing the activity, the importance of the activity and so forth.

In accordance with an alternate aspect, an implementation scheme (e.g., rule) can be applied to control and/or regulate monitoring of activities, generation/modification of forms and/or presentation to a user. It will be appreciated that the rules-based implementation can automatically and/or dynamically provide different forms based upon a predefined criterion. In response thereto, the rule-based implementation can automatically modify a form and/or present a different form by employing a predefined and/or programmed rule(s) based upon any desired criteria (e.g., activity type, activity length, activity importance, user performing the activity, user identity and so forth).

By way of example, a user can establish a rule that can require a trustworthy flag and/or certificate to output a particular form or sequence of forms whereas, other resources within a particular system may not require such security credentials. It is to be appreciated that any preference can be produced through pre-defined or pre-programmed forms of a rule. It is to be appreciated that the rules-based logic can be employed in addition to or in place of the artificial-based components and/or machine-learning component 510.

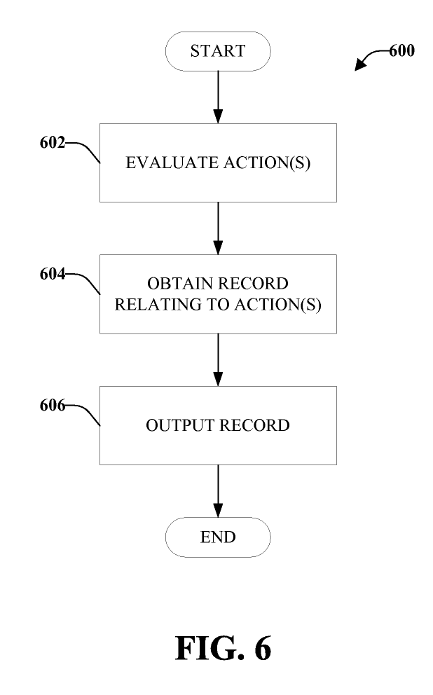

In view of the exemplary systems shown and described above, methodologies that may be implemented in accordance with the disclosed subject matter, will be better appreciated with reference to the flow charts of FIGS. 6-9. While, for purposes of simplicity of explanation, the methodologies are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

With reference now to FIG. 6, illustrated is a method 600 for presenting the user with a form based in part on an observed activity. Method 600 can facilitate efficiency of actions or a sequence of actions by presenting a form (or other perceivable means) to a user for completion of a particular action or sequence of actions.

Method 600 starts, at 602, with evaluation of one or more actions. Such evaluation can be based in part on actions being performed by a user at substantially the same time as such actions are observed. The actions can be performed directly (e.g., input of information) or indirectly (e.g., actions occurring in a particular vicinity or area). The evaluation can also be based on data, such as historical data (e.g., data repository) and/or information that relates to the action (e.g., name of action, name of work process, type of work being performed and so on).

Based on the evaluated actions, a record of such actions is obtained, at 604. The record can be created at substantially the same time as the actions are evaluated, after such evaluation or as a prediction of a next action. In accordance with some aspects, the record can be obtained from a database that contains records (e.g., form repository) that were previously created and stored. Records obtained from a database can be modified, if necessary, to match the evaluated actions. In accordance with some aspects, a modified form is saved separately from a previously created form. Additionally, a particular form can be associated with a certain user and/or equipment or the form can be generic and applied across multiple users and/or equipment.

At 606, the record is presented to a user in one or more forms. For example, the record can be presented to a user on a display screen of an industrial automation control system, a MES Appliance, etc. as a flowchart, a series of steps, a bullet list, a step by step instruction manual or in other forms. In accordance with some aspects, the record can be presented through audio means allowing the user to hear the elements contained in the record. However, other techniques can also be utilized with the disclosed aspects, such as color-coding or through other readily perceivable means.

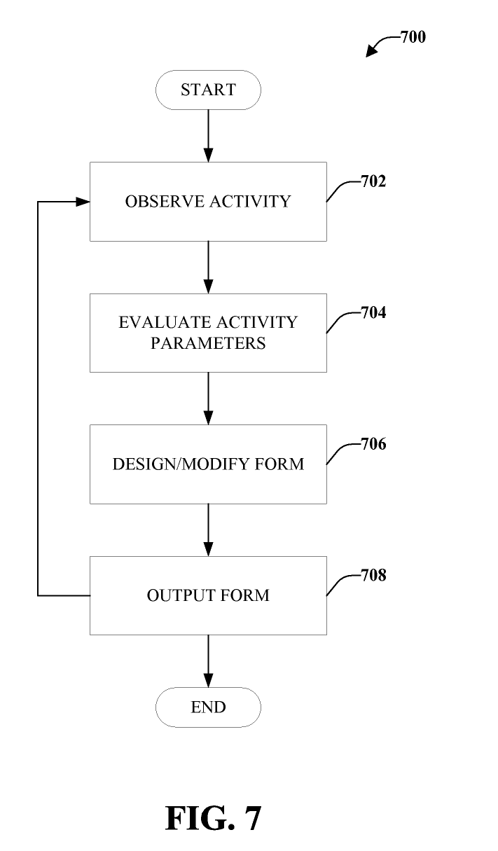

With reference now to FIG. 7, illustrated is a method 700 for dynamically monitoring activities and providing guidance on completion of such activities. The guidance for completion might be directions relating to a more efficient manner of performing the activity, for completing the activity according to specific guidelines (e.g., safety principles, standard operating procedures of a business, and the like) or other manners of completing the activity (e.g., within a specific time frame, with a reduction in scrap, and so forth). In accordance with some aspects, the guidance might be in the form of training whereby a user new to the activity can perform a type of self-training.

Method 700 starts, at 702, with observance of an activity or a set of activities. The observance of activities can occur continuously, at specified intervals, at random intervals, upon a request and so forth. For example, a new procedure (e.g., workflow) might be put into place and it is desired to record the steps involved in that workflow for training of subsequent users. Therefore, observance of the activities might be requested. At 704, one or more parameters associated with the activity are evaluated. Such parameters can include, but are not limited to, experience of a user, age of equipment, known problems with a related or similar activity, guidelines associated with performance of the activity (e.g., safety considerations, output requirements and so forth). Based on the observance of the activity and the one or more parameters, a form can be generated, if there is not an existing form available, or an existing form can be modified, at 706. This new or modified form is output to a user, at 708.

The method 700 can continue at 702, with observance of an activity. For example, if the user is performing a series of activities in a different order than that presented in the form, the user can be notified through available perceivable means (e.g., visual, audio). If a change is necessary to the form, it can be modified, at 706. In accordance with some aspects, monitoring the activity might result in a different form being presented to the user, at 708, if the activities being performed changes. It is to be understood that this act can be continuous such that any number of activities can be observed for generation and/or modification of a form for presentation to a user. Moreover, it is to be appreciated that automated and/or dynamic form changes can be employed in connection with alternate aspects. For example, the system can be configured to automatically present a different form and/or report deviations of a form dynamically in accordance with changes in an observed activity and/or based upon a user request.

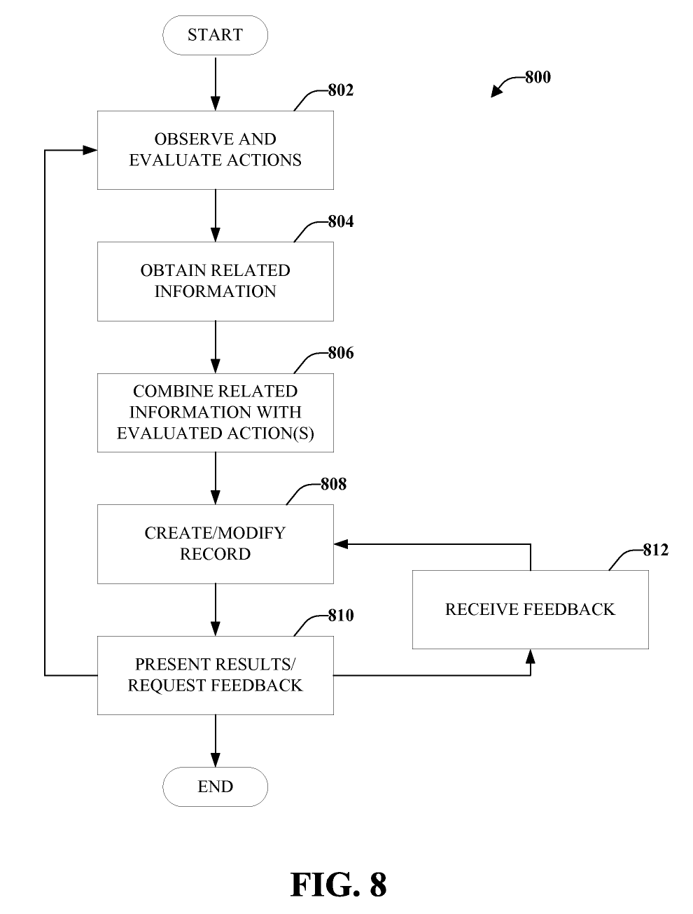

FIG. 8 illustrates a method 800 for providing information relating to an activity or set of activities and modifying information based on requested feedback. At 802, activities are observed and evaluated (e.g., advanced analytics). For example, a camera or other detection means can be utilized to observe activities that occur within a particular area (e.g., workstation) by one or more people. In accordance with some aspects, the detection means can be user inputs relating to the activities being performed, such as through a keyboard or other input means (e.g., voice recognition system) or direct actions (e.g., pressing a start button, opening a safety door, and so on).

At 804, information related to the observed and evaluated activities is obtained. The information can include forms, historical information, information relating to the user and/or activities, information relating to a company for which the activity is being performed and so forth. The related information can be combined with the evaluated activity, at 806, and a record can be created and/or modified at 808. This record is output, at 810, with a request for feedback or more information relating to the activity and/or various aspects relating to the activity. This request for feedback can be in the form of a request to reply to a user prompt, for example.

Feedback information can be received, at 812, and this feedback information can be utilized to modify the form, at 808. In accordance with some aspects, the feedback information can result in a different form being created and/or modified. The feedback information can be provided by a user, such as through a user interface, a voice recognition system or other means of interaction.

Additionally, the actions can be continuously monitored at 802, and, if reasonable, the record is modified and/or a new form created. For example, an activity can be monitored and a record presented to the user. As activities are performed and completed, the activity might change (e.g., user continues with a next process) and this change might result in a completely different form. This change can be observed and the different form automatically presented to the user, at 810.

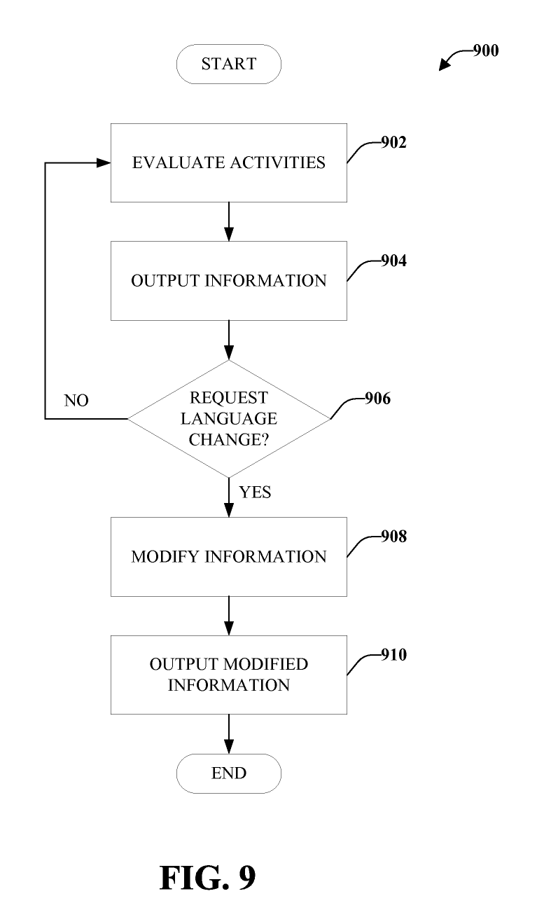

With reference now to FIG. 9, illustrated is a method for 900 providing information relating to evaluated activities and dynamically altering a language of the output based upon a request for such a change. Method 900 allows a user, such as a machine operator, to log onto a machine (e.g., enter a username/password pair) or simply use a machine. At anytime, the user can request a change to the language, without requiring a sign on/sign off process.

Method 900 starts, at 902, where activities are evaluated, which can be similar to the evaluation of activities described above. At 904, information (e.g., form, parameters relating to a task or machine, or other perceivable manner of conveying any type of information) is output to a user.

At 906, a determination is made whether a request for a change from a first language to a second language is received. If a request is not received (“NO”), method 900 continues, at 902, with evaluation/observance of activities. If a request for a language change is received (“YES”), method 900 continues, at 908, where the information is modified based in part on the selected language.

For example, number formatting might need to be changed depending on which language was chosen. Date formatting might also need to be changed. For some languages, the format of reading the written language might need to be altered (e.g., reading from left to right versus reading from right to left). Additionally, translation from one language to another might need to be interpreted and selectively applied so that the translation between the languages is correct. At 910, the information is presented to the user in the requested language.

It should be understood that a request to change the language can be made multiple times. Additionally, if a form or other outputted information should be changed based in part on the observed activities, the information will be presented to the user in the language currently selected by the user (until a request to change the language is received). In such a manner, the user can selectively request a language change and the information presented to the user can be dynamically changed while mitigating errors in the formatting and presentation of the requested language.

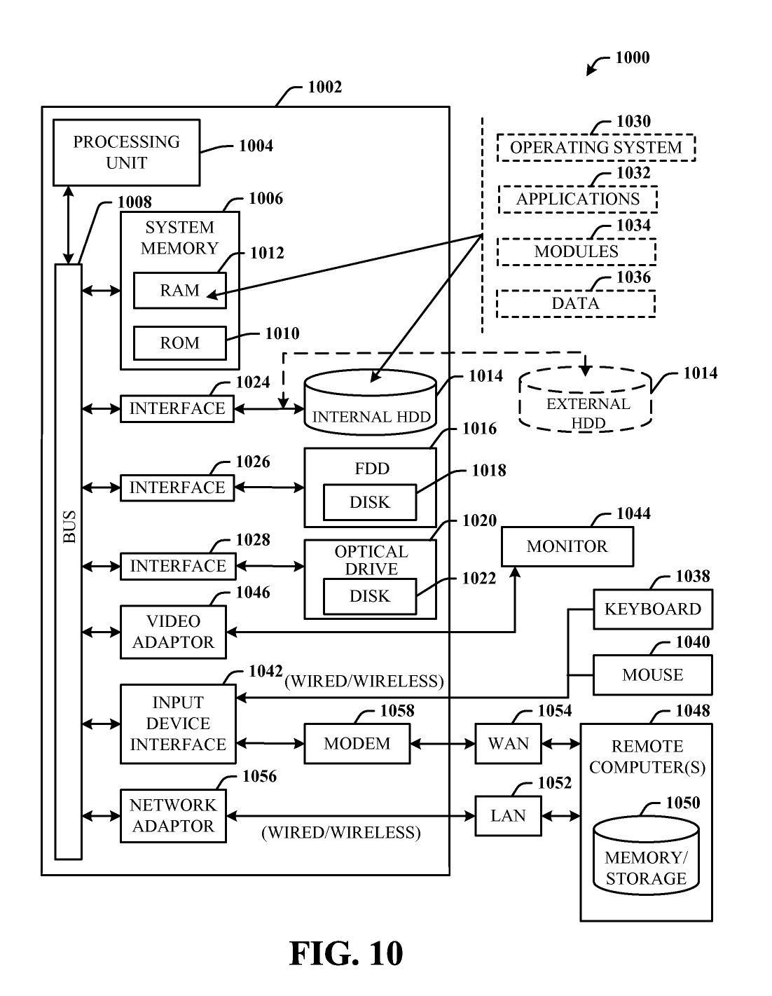

Referring now to FIG. 10, there is illustrated a block diagram of a computer operable to execute the disclosed architecture. In order to provide additional context for various aspects disclosed herein, FIG. 10 and the following discussion are intended to provide a brief, general description of a suitable computing environment 1000 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 may operate in a networked environment using logical connections through wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

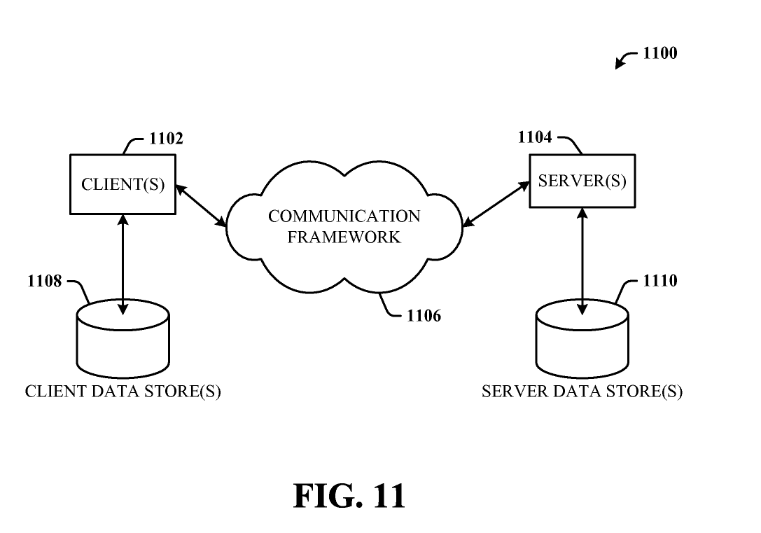

Referring now to FIG. 11, there is illustrated a schematic block diagram of an exemplary computing environment 1100 in accordance with the various embodiments. The system 1100 includes one or more clients 1102. The client(s) 1102 can be hardware and/or software (e.g., threads, processes, computing devices). The client(s) 1102 can house cookie(s) and/or associated contextual information by employing the various embodiments, for example.

The system 1100 also includes one or more servers 1104. The servers 1104 can also be hardware and/or software (e.g., threads, processes, computing devices). The servers 1104 can house threads to perform transformations by employing the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated through a wired (including optical fiber) and/or wireless technology. The client(s) 1102 are operatively connected to one or more client data stores 1108 that can be employed to store information local to the client(s) 1102 (e.g., cookie(s) and/or associated contextual information). Similarly, the server(s) 1104 are operatively connected to one or more server data stores 1110 that can be employed to store information local to the servers 1104.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system that automatically generates a form within an industrial automation environment, comprising:
an evaluation component that monitors at least one activity;
a generation component that creates a form that is a representation of the at least one activity; and
an output component that presents the form to a user in response to the monitored at least one activity.

2. The system of claim 1, the evaluation component further evaluates one or more parameters that influence the at least one activity.

3. The system of claim 1, the evaluation component identifies a sequence of a plurality of actions or a consistency in the plurality of actions.

4. The system of claim 1, the generation component further retrieves information from a data repository and considers the retrieved information when creating the form.

5. The system of claim 1, the generation component obtains a previously created form from a form repository, wherein the previously created form relates to the at least one activity.

6. The system of claim 5, the generation component automatically modifies the previously created form based on a determination that the created form is no longer accurate.

7. The system of claim 1, the generation component provides a different form if the created form does not apply to a current situation.

8. The system of claim 1, further comprising an interface component that accepts a user input relating to form modifications.

9. The system of claim 1, further comprising a language component that selectively changes the presented form from a first language to a second language.

10. The system of claim 9, the language component changes the language based on a user request.

11. The system of claim 1, the output component presents the form to the user in a visual format or an audible format.

12. The system of claim 1, further comprising a machine-learning component that facilitates automation of one or more system components.

13. A method for enabling automatic user guidance for completion of one or more actions, comprising:
evaluating at least one performed action;
obtaining a record relating to the evaluated at least one action, the record relates to guidance for completion of the at least one action; and
presenting the record to a user.

14. The method of claim 13, further comprising:
evaluating one or more parameters associated with the at least one action; and
modifying the obtained record based in part on the one or more parameters.

15. The method of claim 13, further comprising:
requesting feedback from a user relating to the record;
receiving feedback information; and
selectively modifying the record based on the received feedback.

16. The method of claim 13, further comprising:
evaluating at least a second action;
determining if the at least a second action is a sequence that contains the at least first action; and
selectively modifying the record based on the determination.

17. The method of claim 16, selectively modifying the record comprising:
obtaining a different record relating to the at least a second action; and
presenting the different record to the user.

18. The method of claim 13, further comprising:
receiving a request to change a language of the output record;
selectively changing the record to the requested language; and
outputting the record in the selected language.

19. A system that facilitates presenting a user with a workflow at an optimal time for efficiency purposes, comprising:
means for evaluating one or more activities to determine if the one or more activities occur in a sequence;
means for creating or modifying a form that contains a workflow based in part on the evaluated one or more activities; and
means for presenting the form to a user to enable efficiency of performance of the workflow.

20. The system of claim 19, further comprising:
means for receiving a request to change the form from a first language to a second language; and
means for selectively altering the form based on the received request, the means for presenting the form presents the altered form to the user.
